(19) United States
(12) Patent Application Publication
(10) Pub. No.: US 2015/0185629 A1
(43) Pub. Date: Jul. 2, 2015

(54) Photoconductors Having Titanyl Phthalocyanine and Bisazo Pigments in Dual Charge Generation Layers

(71) Applicant: Lexmark International, Inc., Lexington, KY (US)

(72) Inventor: David Glenn Black, Broomfield, CO (US)

(73) Assignee: Lexmark International, Inc., Lexington, KY (US)

(21) Appl. No.: 14/142,449

(22) Filed: Dec. 27, 2013

(51) Int. Cl. G03G 5/06

(52) U.S. Cl. CPC G03G 5/0629

(57) ABSTRACT

A photoconductor with dual charge generation layers is provided. The photoconductor comprises an electrically conductive substrate, a first charge generation layer comprising titanyl phthalocyanine disposed over the electrically conductive substrate, a second charge generation layer comprising a bisazo pigment disposed over the first charge generation layer, and a charge transport layer disposed over the second charge generation layer. The photoconductor having dual charge generation layers provides improved sensitivity at 780 nm, 650 nm, and 450 nm compared to a photoconductor having a single titanyl phthalocyanine-based charge generation layer.

### STATEMENT REGARDING FEDERALLY SPONSORED RESEARCH OR DEVELOPMENT

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

Embodiments of the invention are generally directed to photoconductors and are specifically directed to photoconductors comprising charge generation layers having mixtures of titanyl phthalocyanine and bisazo pigment.

2. Description of the Related Art

In electrophotography, a latent image is created on the surface of an imaging member such as a photoconducting material by first uniformly charging the surface and then selectively exposing areas of the surface to light. A difference in electrostatic charge density is created between those areas on the surface which are exposed to light and those areas on the surface which are not exposed to light. The latent electrostatic image is developed into a visible image by electrostatic toners. The toners are selectively attracted to either the exposed or unexposed portions of the photoconductor surface, depending on the relative electrostatic charges on the photoconductor surface, the development electrode and the toner. Electrophotographic photoconductors may be a single layer or a laminate formed from two or more layers (multi-layer type and configuration).

Typically, a dual layer electrophotographic photoconductor comprises a substrate such as a metal ground plane member on which a charge generation layer (CGL) and a charge transport layer (CTL) are coated.

When the charge transport layer containing a hole transport material is formed on the charge generation layer, a negative charge is typically placed on the photoconductor surface. Conversely, when the charge generation layer is formed on the charge transport layer, a positive charge is typically placed on the photoconductor surface. Most photoconductors for use in modern electrophotographic laser printers are of the dual layer, negative charging type. Most commercial laser printers employ discharge area development (DAD), whereby toner is attracted to portion of the drum that has been exposed to light. Conventionally, the charge generation layer comprises the charge generation compound or molecule alone and/or in combination with a binder. A charge transport layer typically comprises a polymeric binder and a charge transport compound or molecule. The charge generation compounds within the charge generation layer are sensitive to image-forming radiation and create electron-hole pairs therein as a result of absorbing such radiation. The hole may be viewed as a positive charge. This process is known as photogeneration. The electron-hole pair is separated under the influence of a strong electric field. For negative charging photoconductors, the hole migrates through the charge transport layer and discharges the negative charge at the surface. The charge transport layer is usually non-absorbent of the image-forming radiation and the charge transport compounds serve to transport holes to the surface of the photoconductor. The photoconductor is designed to create a contrast in electrical potential between regions that have been exposed to image-forming radiation and regions that have not been exposed. High electrical contrast develops more image producing material, such as toner, and results in darker prints.

Charge generation layers are generally prepared by dispersing a pigment (e.g., phthalocyanines, azo compounds, squaraines, etc.) in a polymeric matrix, along with other optional additives. Since the pigment or dye in the charge generation layer typically does not have the capability of binding or adhering effectively to a metal substrate, the polymer binder and optional additives are added to form stable dispersion, provide adherence to the metal substrate, improve coatability and change the electrical properties of the pigment.

Titanylphtoalocyanine is a well-known charge generation pigment. Titanyl phthalocyanine is regarded as a p-type semiconductor. P-type semiconductors are efficient at generating holes, but much less efficient at generating electrons (negative charge). Generation of holes in a charge generation layer, requires absorption of light in order to generate the electron-hole pair. Titanyl phthalocyanine has high light absorption in two regions, the Soret-band (300 nm-420 nm) and the Q-band (500 nm-850 nm). The absorption maxima in these regions is between about 350 nm to about 375 nm (Soret-band), and between about 780 nm to about 810 nm (Q-band). There is a range for the absorption maxima because solid state films prepared by milling and coating pigment dispersions in the presence of a binder give broad absorptions. In other words, high light absorption means the potential for greater electron-hole pair formation. Regions of lower light absorption, such as between about 500 nm to about 700 nm have lower levels of electron-hole pair formation. Light sources, such as lasers or LEDs, with emission wavelengths near the absorption max of titanyl phthalocyanine, are therefore best used for this charge generation pigment. For example, a 780 nm solid state laser is often paired with titanyl phthalocyanine charge generation layers in modern laser printers.

In one conventional charge generation layer, Type IV titanyl phthalocyanine is utilized to produce a highly sensitive negative charging photoconductor. Type IV is also referred to as type in in the phthalocyanine literature. Photoreceptor sensitivity refers to the rate at which a photoconductor discharges a surface potential upon absorption of light. Highly sensitive photoconductors undergo very rapid discharge of surface potential upon absorption of light. This process is known as photo-induced discharge (PID). One requirement for high sensitivity requires use of a charge generating pigment with high photogeneration efficiency. In other words, a significant fraction of light that is absorbed molecules within the pigment particles leads to production of electron-hole pairs. For Type IV titanyl phthalocyanine charge generation layers, as much as 90% of the absorbed light leads to production of electron-hole pairs. Consequently, pairing the wavelength of the light source with the absorption maximum of the charge generation pigment produces the greatest number of electron-hole pairs and produces the most sensitive photoconductors. Increasing photoconductor sensitivity is important for the development of high speed laser printers.

Various processing treatments have been described in the titanyl phthalocyanine literature that allows access to different polymorphic crystal structures. Polymorphism refers to the intermolecular stacking of titanyl phthalocyanine molecules within the pigment particle. Crystal forms possessing high sensitivity, such as Type IV titanyl phthalocyanine, have intermolecular stacking properties that promote high photogeneration efficiency and rapid (PID) of negatively charged photoconductors. Other polymorphic structures, such as Type I, have lower photogeneration efficiency and undergo much slower photo-induced discharge. Some polymorphs of titanyl phthalocyanine, such as Type I and Type IV, are metastable. In other words, addition of sufficient energy, such as by over milling, will lead to a change in crystal structure. Care must be taken when milling metastable polymorphs of titanyl phthalocyanine to maintain the polymorphic structure. Combining Type I and Type IV titanyl phthalocyanine pigment particles may be used to modulate between high and low sensitivity photoconductors. Polymorphs of titanyl phthalocyanine are discussed in U.S. Pat. No. 5,166,339.

As noted above, titanyl phthalocyanine has very little absorption between 420 nm and 500 nm. Consequently, image writing light sources that emit in this region will not enable a functional laser printer. Biszo pigments, on the other hand, often provide functional photoconductors due, in part, to high levels of light absorption in this wavelength region. Some bisazo pigments show efficient photogeneration from about 400 nm to about 670 nm, and thus both complement and supplement the useful wavelength range of titanyl phthalocyanine. Bisazo pigments are regarded as n-type semiconductors. N-type semiconductors are efficient at generating electrons, but much less efficient at generating holes (positive charge). Consequently, bisazo pigments typically show lower sensitivity than titanyl phthalocyanine pigments in negative charging photoconductor applications. Combining the p-type semiconductor titanyl phthalocyanine with the n-type azo pigment addresses the low wavelength sensitivity of titanyl phthalocyanine from about 420 nm to about 500 nm and represents a motivation for the present work. A second motivating factor was a desire to increase the sensitivity of titanyl phthalocyanine-based photoconductors from about 500 nm to about 780 nm.

Without wishing to be bound by theory, the inventor believes that the n-type bisazo pigment is acting as a sensitizer to the p-type titanyl phthalocyanine. Sensitization results from the dual charge generation layer structure by providing intimate contact between the p-type titanyl phthalocyanine and the n-type bisazo pigment particles. The result is enhanced charge generation efficiency, and thus greater sensitivity for the p-type titanyl phthalocyanine, especially in higher wavelength regions, such as around 780 nm.

### SUMMARY OF THE INVENTION

In accordance with one embodiment, a photoconductor with dual charge generation layers is provided. The photoconductor comprises an electrically conductive substrate, a first charge generation layer comprising titanyl phthalocyanine disposed over the electrically conductive substrate, a second charge generation layer comprising a bisazo pigment disposed over the first charge generation layer, and a charge transport layer disposed over the charge generation layer.

In accordance with another embodiment, a method of preparing a photoconductor with dual charge generation layers is provided. The method comprises the steps of (1) providing an electrically conductive substrate, (2) preparing and coating a first charge generation layer dispersion over the electrically conductive substrate to prepare a first charge generation layer comprising titanyl phthalocyanine, (3) preparing and coating a second charge generation layer dispersion over the first charge generation layer to create a second charge generation layer comprising a bisazo pigment and (3) preparing and coating a charge transport layer over the second charge generation layer to form the photoconductor.

These and additional objects and advantages provided by the embodiments of the present invention will be more fully understood in view of the following detailed description, in conjunction with the drawings.

### BRIEF DESCRIPTION OF THE DRAWINGS

The following detailed description of specific embodiments of the present invention can be best understood when read in conjunction with the drawings enclosed herewith wherein:

FIG. 1 is a schematic cross sectional view of a photoconductor according to one or more embodiments of the present invention.

FIG. 2 is a schematic illustrating a photoconductor in conjunction with a developing unit, cleaning unit, charging roller, etc. according to one or more embodiments of the present invention.

FIG. 3 is the absorbance spectrum of a Type IV titanyl phthalocyanine dispersion coated over Mylar™.

FIG. 4 shows the voltage versus exposure energy curves (780 nm) for a photoconductor comprising a first charge generation layer comprising Type IV titanyl phthalocyanine and a second charge generation layer comprising a bisazo pigment coated over the first charge generation layer versus a titanyl phthalocyanine-based photoconductor and a bisazo-based photoconductor.

FIG. 5 shows the voltage versus pulse width modulation (PWM) curves for a photoconductor comprising a first charge generation layer comprising Type IV titanyl phthalocyanine and a second charge generation layer comprising a bisazo pigment versus a titanyl phthalocyanine-based photoconductor and a bisazo pigment-based photoconductor recorded in a Lexmark E460dn monochrome laser printer.

FIG. 6 shows voltage versus exposure energy curves (450 nm) for a photoconductor comprising a first charge generation layer comprising Type IV titanyl phthalocyanine and a second charge generation layer comprising a bisazo pigment versus a titanyl phthalocyanine-based photoconductor.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION

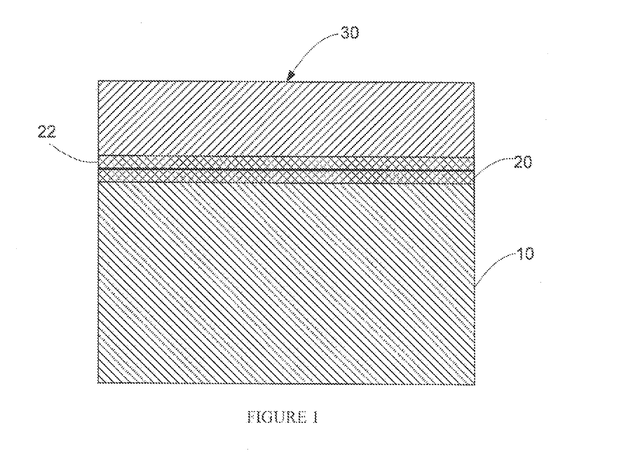

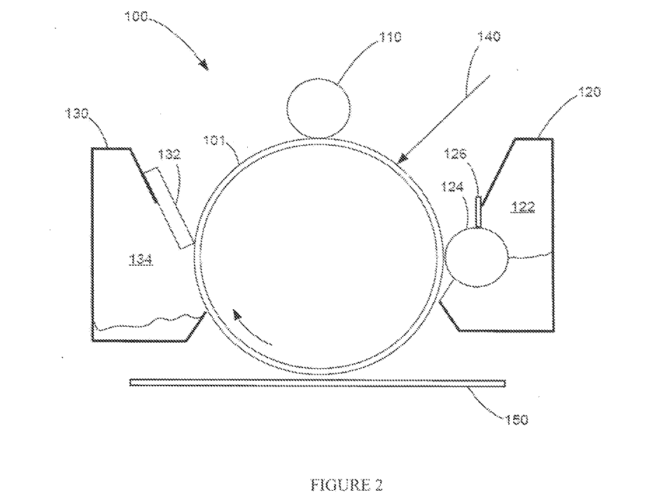

Embodiments of the present invention are directed to photoconductors and methods of making photoconductors. Referring to FIG. 1, the photoconductor 1 comprises an electrically conductive substrate 10, and a first charge generation layer 20 disposed over the electrically conductive substrate 10. As used herein, “over” may mean one layer is directly on another layer, or may also allow for intervening layers therebetween. The first charge generation layer 20 comprises titanyl phthalocyanine. Photoconductor 1 also comprises a second charge generation layer 22 disposed over the first charge generation layer 20. The second charge generation layer 22 comprises a bisazo pigment. Further as shown, the photoconductor 1 comprises a charge transport layer 30 disposed over the charge second charge generation layer 22. As shown in FIG. 2, the photoconductor 1 is in the form of a drum; however, other embodiments are contemplated herein.

Referring to FIG. 1, the electrically conductive substrate 10 comprises an electrically conductive metal based material. The substrate 10 may be flexible, for example in the form of a flexible web or a belt, or inflexible, for example in the form of a drum. Typically, the photoconductor substrate is uniformly coated with a thin layer of metal, preferably aluminum which functions as an electrical ground plane. In one embodiment, the electrically conductive substrate 10 comprises an anodized and sealed aluminum core. Alternatively, the ground plane member may comprise a metallic plate formed, for example, from aluminum or nickel, a metal drum or foil, or plastic film on which aluminum, tin oxide, indium oxide or the like is vacuum evaporated. Typically, the substrate 10 will have a thickness adequate to provide the required mechanical stability. For example, flexible web substrates generally have a thickness of from about 0.01 to about 0.1 microns, while drum substrates generally have a thickness of from about 0.75 mm to about 1.0 mm.

The first charge generation layer 20 comprises titanyl phthalocyanine, binder and optional additives. The titanyl phthalocyanine may be in the form of a pigment dispersed inside a binder. The first charge generation layer is formed by preparing a first charge generation layer dispersion comprising titanyl phthalocyanine, binder, optional additives and solvent, and coating this mixture over a conductive substrate. The titanyl phthalocyanine may comprise Type I titanyl phthalocyanine, Type IV titanyl phthalocyanine, or combinations thereof. As noted above, Type I and Type IV are different yet operable crystal structures of titanyl phthalocyanine, Type IV demonstrates increased photoconductor sensitivity. Typically, purity, crystal structure, morphology and dispersion preparation conditions all influence the photoconductor sensitivity.

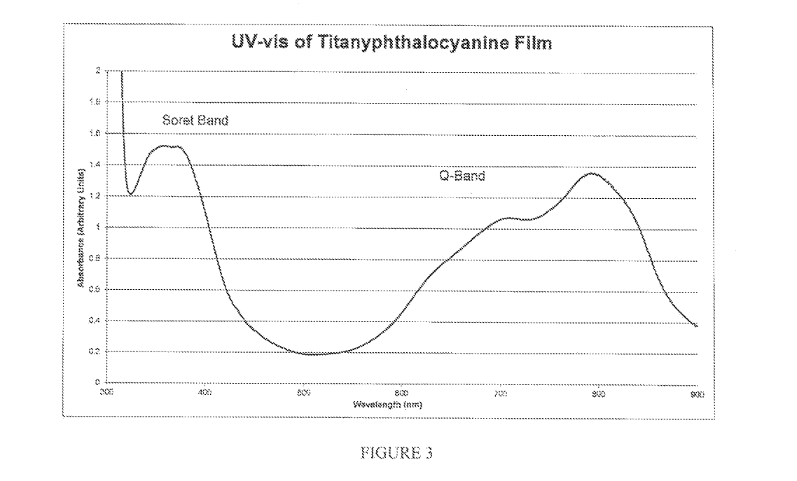

In the examples provided below, the first charge generation layer is deposited over the electrically conductive substrate and comprises Type IV titanyl phthalocyanine. FIG. 3 shows the absorption spectrum of a Type IV titanyl phthalocyanine dispersion coated over Mylar™. The Soret-band lies in the UV region of the electromagnetic spectrum. The Q-band is more difficult to resolve, but begins just above 500 nm. Since photoconductor sensitivity is proportional to the absorbance of the charge generation layer, the highest sensitivity is derived from light emission sources between 350 nm and 375 nm (Soret-band) and around 790 nm (Q-band).

The second charge generation layer 22 comprises a bisazo pigment, binder and optional additives. The bisazo pigment may be in the form of a pigment dispersed in a binder. The second charge generation layer is formed by preparing a second charge generation layer dispersion comprising a bisazo pigment, binder, optional additives and solvent, and coating this mixture over the first charge generation layer.

The second charge generation layer dispersion comprising a bisazo pigment is deposited over the first charge generation layer generation. A bisazo pigment having the following formula (1) can effectively be used:

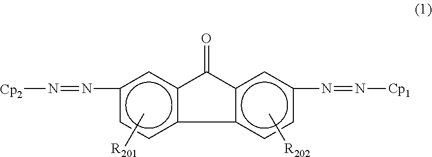

where Cp₁ and Cp₂ each independently represent a coupler residue, and R₂₀₁ and R₂₀₂ each independently represent a hydrogen atom, a halogen atom, an alkyl group, an alkoxy group or a cyano group.

In addition, Cp₁ and Cp₂ have the following formula (2):

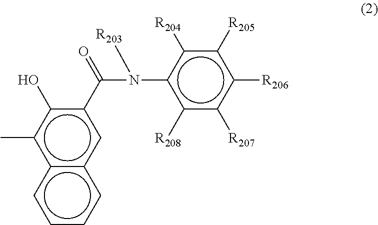

where R₂₀₃ independently represents a hydrogen atom, an alkyl group or an aryl group. R₂₀₄, R₂₀₅, R₂₀₆, R₂₀₇ and R₂₀₈ each independently represent a hydrogen atom, a halogen atom a nitro group, a cyano group, an alkyl group, an alkoxy group, a dialkylamino group or a hydroxyl group. In an exemplary embodiment, the bisazo compound has the following formula (3):

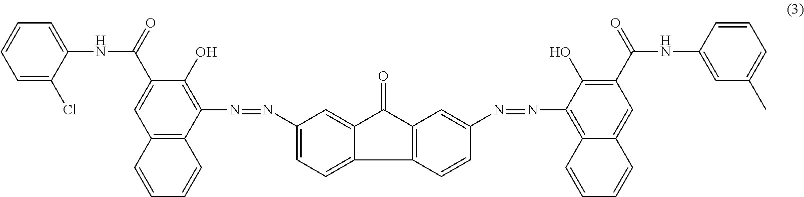 [SMILES: Cc1cccc(NC(=O)c2cc3ccccc3c(N=Nc3ccc4c(c3)C(=O)c3cc(N=Nc5c(O)c(C(=O)Nc6ccccc6Cl)cc6ccccc56)ccc3-4)c2O)c1]

The binder of the first charge generation layer dispersion and the second charge generation layer dispersion may comprise various compositions familiar to one of ordinary skill in the art. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like resins.

The weight ratio of pigment to binder for first charge generation layer dispersion and the second charge generation layer dispersion should be sufficient to provide adequate dispersion stability and coating quality, but should not significantly diminish the charge generation properties of the pigment. In an exemplary embodiment, the weight ratio pigment (titanyl phthalocyanine or bisazo pigment) to binder for the first and second charge generation layers ranges from about 30/70 to about 90/10. The pigment to binder ratio for the dispersions is the same as the pigment to binder ratio for the respective charge generation layers since the solvent is removed after coating by evaporation.

The first charge generation layer dispersion and the second charge generation layer dispersion may optionally comprise various additives such sensitizers, dispersants, polymers, surfactants and silicone oils. Charge layer dispersion additives may be included to alter electrostatics of the coated charge generation layer, improve coating uniformity, or improve dispersion stability. Examples of optional additives include as poly(methyl-phenyl)siloxane, polyhydroxystyrene, and phenolic novolac. The optional additives may be viewed as part of the binder system, since they remain as part of the first charge generation layer and second charge generation layer after coating and solvent evaporation.

The solvent of the first charge generation layer dispersion and the second charge generation layer dispersion include organic solvents such as isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, and ligroin. Among these solvents, ketones, esters and ethers are preferably used. These solvents can be used alone or in combination.

The first charge generation layer dispersion and the second charge generation layer dispersion of the present invention may be prepared by milling the respective pigment, binder and optional additives with solvent in a milling machine such as a gyromixer, ball mill, attritor, sand mill or ultrasonic milling machines.

The first charge generation layer is typically prepared by coating the above-prepared first charge generation layer dispersion on an electroconductive, followed by drying. Suitable coating methods include known coating methods such as dip coating, spray coating, bead coating, nozzle coating, spinner coating and ring coating. After coating, the solvent is partially or substantially removed either by standing at room temperature, or by heating the coated drum to between 50° C. and 120° C. A significant portion of the solvent may be removed by standing at room temperature because the first charge generation layer is very thin. In one embodiment, the first charge generation layer is allowed to dry at room temperature for 1 hour. Referring to the embodiment of FIG. 1, the first charge generation layer 20 may comprise a thickness of about 0.1 μm to about 1.0 μm, or preferably about 0.2 μm to about 0.3 μm.

The second charge generation layer is typically prepared by coating the above-prepared second charge generation layer dispersion on the first charge generation layer, followed by drying. The time in between coating the second charge generation layer dispersion over the first charge generation layer is not particularly limiting, and may range from about 5 minutes to about 12 hours. Suitable coating methods include known coating methods such as dip coating, spray coating, bead coating, nozzle coating, spinner coating and ring coating. After coating, the solvent is partially or substantially removed either by standing at room temperature, or by heating the coated drum to between 50° C. and 120° C. A significant portion of the solvent may be removed by standing at room temperature because the second charge generation layer is very thin. In one embodiment, the second charge generation layer is allowed to dry at room temperature for 1 hour. Referring to the embodiment of FIG. 1, the charge generation layer 22 may comprise a thickness of about 0.1 μm to about 1.0 μm, or preferably about 0.2 μm to about 0.3 μm. Note that the first charge generation layer and the second charge generation layer each independently comprise a thickness of about 0.1 μm to about 1.0 μm, or preferably about 0.2 μm to about 0.3 μm.

As shown in the examples below, the photoconductors comprising a first charge generation layer comprising titanylphthalocyanine and a second charge generation layer comprising a bisazo pigment provide higher sensitivity at 780 nm, 650 nm and 450 nm than a photoconductor comprising only a titanyl phthalocyanine based charge generation layer.

The charge transport layer is prepared by coating a charge transport layer formulation comprising one or more charge transport molecules, binder, optional additives and solvent over the charge generation layer. In one embodiment, the charge transport layer may comprise an aromatic amine. In an exemplary embodiment, the charge transport layer is comprised of a mixture of tritolylamine (TTA) and 1,1 bis(di-4-tolylaminophenyl)cyclohexane (TAPC).

Other charge transport molecules are contemplated herein. For example, and not by way of limitation, the charge transport molecules may comprises pyrazoline, fluorene derivatives, oxadiazole transport molecules such as 2,5-bis(4-diethylaminophenyl)-1,3,4-oxadiazole, imidazole, and triazole, hydrazone transport molecules including p-diethylaminobenzaldehyde-(diphenylhydrazone), p-diphenylaminobenzaldehyde-(diphenylhydrazone), o-ethoxy-p-diethylaminobenzaldehyde-(diphenylhydrazone), o-methyl-p-diethylaminobenzaldehyde-(diphenylhydrazone), o-methyl-p-dimethylaminobenzaldehyde(diphenylhydrazone), p-dipropylaminobenzaldehyde-(diphenylhydrazone), p-diethylaminobenzaldehyde-(benzylphenylhydrazone), p-dibutylaminobenzaldehyde-(diphenylhydrazone), p-dimethylaminobenzaldehyde-(diphenylhydrazone). Other suitable hydrazone transport molecules include compounds such as 1-naphthalenecarbaldehyde1-methyl-1-phenylhydrazone, 1-naphthalenecarbaldehyde1,1-phenylhydrazone, 4-methoxynaphthlene-1-carbaldehyde1-methyl-1-phenylhydrazone, carbazole phenyl hydrazones such as 9-methylcarbazole-3-carbaldehyde-1,1-diphenylhydrazone, 9-ethylcarbazole-3-carbaldehyde-1-methyl-1-phenylhydrazone, 9-ethylcarbazole-3-carbaldehyde-1-ethyl-1-phenylhydrazone, 9-ethylcarbazole-3-carbaldehyde-1-ethyl-1-benzyl-1-phenylhydrazone, 9-ethylcarbazole-3-carbaldehyde-1,1-diphenylhydrazone, derivatives of aminobenzaldehydes, cinnamic esters or hydroxylated benzaldehydes. Diamine and triarylamine transport molecules such as N,N-diphenyl-N,N-bis(alkylphenyl)[1,1′-biphenyl]-4,4′-diamines wherein the alkyl is, for example, methyl, ethyl, propyl, n-butyl, or the like, or halogen substituted derivatives thereof, commonly referred to as benzidine and substituted benzidine compounds, and the like are also contemplated herein. Typical triarylamines include, for example, tritolylamine, and the like.

The binder of the charge transport layer formulation should be transparent to the image forming radiation, and also be chemically inert. Specific examples of the binder resin include thermoplastic resins, thermosetting resins such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like. In one embodiment, the binder of the charge transport layer formulation is polycarbonate.

The charge transport layer formulation of the present invention may include additives such as plasticizers and leveling agents. Specific examples of the plasticizers include known plasticizers, which are used for plasticizing resins, such as dibutyl phthalate, dioctyl phthalate and the like. The addition quantity of the plasticizer is 0% to 30% by weight of the binder resin. Specific examples of the leveling agents include silicone oils such as dimethyl silicone oil, and methyl phenyl silicone oil; polymers or oligomers including a perfluoroalkyl group in their side chain; and the like. The addition quantity of the leveling agents is 0% to 1% by weight of the binder resin.

Suitable solvents for use in the charge transport layer formulation include tetrahydrofuran, dioxane, toluene, dichloromethane, monochlorobenzene, dichloroethane, cyclohexanone, methyl ethyl ketone, acetone and the like solvents. In one embodiment, the solvent for use in the charge transport layer formulation is a mixture of tetrahydrofuran and dioxane.

The charge transport layer is typically prepared by coating the above-prepared charge transport layer formulation on the second charge generation layer, followed by drying. Suitable coating methods include known coating methods such as dip coating, spray coating, bead coating, nozzle coating, spinner coating and ring coating. After coating, the solvent is substantially removed by heating the coated drum to between 50° C. and 140° C. A substantial portion of the solvent should be removed from the charge transport layer so that an abrasion resistant film is formed. Allowing a substantial amount of solvent to remain within the charge transport layer also leads to negative electrical effects for the photoconductor. Care must be taken to not heat the coated photoconductor too high, or low molecular weight components of the charge transport layer may be removed by, for example, sublimation. In one embodiment, the charge generation layer is dried at 100° C. for 1 hour. Referring to the embodiment of FIG. 1, the charge transport layer may comprise a thickness about 15 μm to about 30 μm.

After the first charge generation layer 20 comprising titanyl phthalocyanine is coated on the electrically conductive substrate 10, the second charge generation layer 22 comprising a bisazo pigment is deposited over the first charge generation layer. The charge transport layer 30 is coated on the second charge generation layer 22 to form the photoconductor 1.

The photoconductor of the present invention may be utilized in various printer configurations familiar to one of ordinary skill in the art. On such configuration is illustrated in FIG. 2. The image forming apparatus 100 (e.g., a printer) may comprise a photoconductor 101, a charging roller 110, a developer unit 120 and a cleaner unit 130. The charging roller 110 negatively charges the surface of the photoconductor 101. The charged surface of the photoconductor may then be irradiated by a laser light source 140 to form an electrostatic latent image on the photoconductor 101 corresponding to an image. The developing unit 120 may include a toner sump 122, a developer roller 124 and a toner metering device 126. Toner in the sump is transferred to the surface of developer roll 124 by various means including a toner transfer roller (not shown). The toner metering device 126 such as a doctor blade serves as a means of providing a uniform layer of toner on the developer roller 124. The developer roller 124 and doctor blade 126 can be charged which in turn charges the toner. The charged toner is attached to the latent image on the photoconductor 101. The image from the photoconductor 101 may be transferred directly to a recording medium, (e.g., paper 200) or may utilize an intermediate transfer belt (not shown) to transfer the image to the paper 200. A fusing unit (not shown) is used to fuse the toner image to the paper 200. A cleaning unit 130 uses a cleaning blade 132 to scrape off any residual toner still adhering to the photoconductor 101 after the image is transferred to the paper 200. The cleaned surface of the photoconductor can now be charged again, repeating the imaging and printing cycle. The waste toner 134 is held in a waste toner sump in the cleaning unit 130.

### EXAMPLES

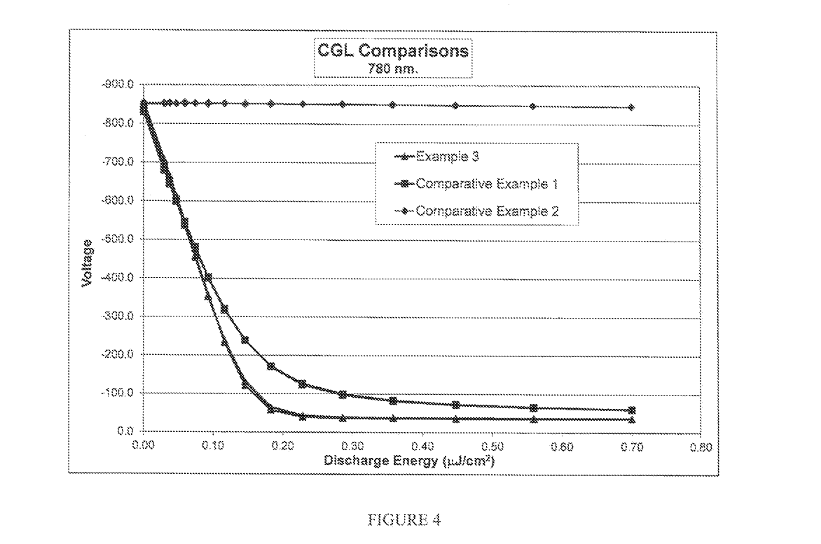

To demonstrate the improved properties of the photoconductors comprising a first charge transport layer comprising titanylphthalocyanine and a second charge generation layer comprising a bisazo pigment deposited over the first charge generation layer, the following experimental examples are provided. The data presented in FIG. 4 was derived using the test method and algorithm described below.

The photo-electrostatic properties of a photoconductor are evaluated at an exposure wavelength of 780 nm with an in-house built electrostatic tester. The architecture of the electrostatic tester is similar to a printer base system. The main components include a charge roll, a high speed electrostatic probe, an erase lamp, and a low-power laser. To ensure correct operation, each of these components is oriented at specified locations and distances. The tester and the test sequence is software controlled. Below is a brief description of the test algorithm.

Negative AC or DC charge is applied to the charge roll shaft. The charge roll and the photoconductor are in contact and are rotating at a constant speed. The interface between the charge roll and photoconductor induces a negative charge voltage on the photoconductor. Charge voltage is specific to a product.

Once the desired charge level is reached on the photoconductor, the laser will turn on, effectively discharging the charge level at the specified location. The electrostatic probe will then measure this discharge level. This step can be construed as the expose to develop time. The rotational speed of the photoconductor usually remains constant. In order to emulate a particular printer speed, the distance between the laser and the electrostatic probe is adjusted. A short distance will emulate a fast printer whereas, a wider distance a slow printer.

Once the discharge voltage is recorded, the erase lamp will neutralize the remaining amount of voltage on the photoconductor. Measurements are recorded at various laser powers.

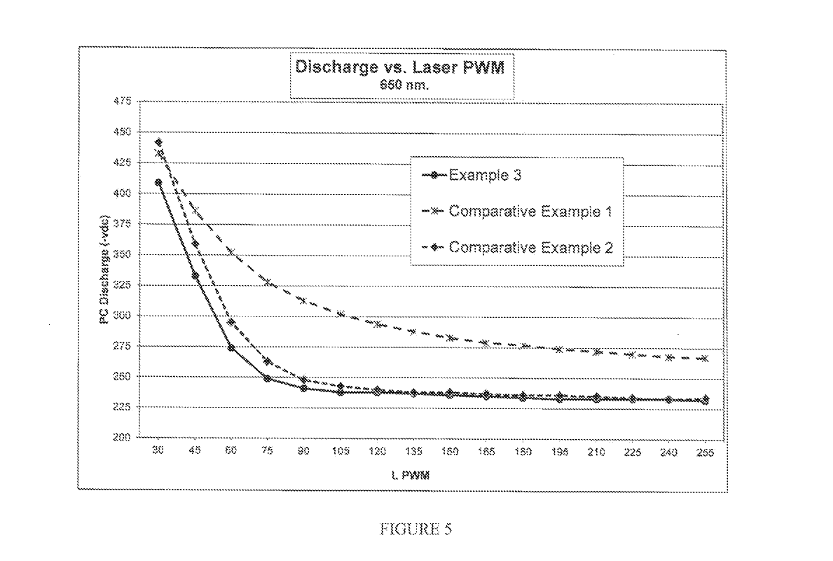

The data presented in FIG. 5 was derived using a Lexmark E460dn monochrome laser printer equipped to measure electrostatic charge on the photoconductor. The emission source is a 650 nm LED.

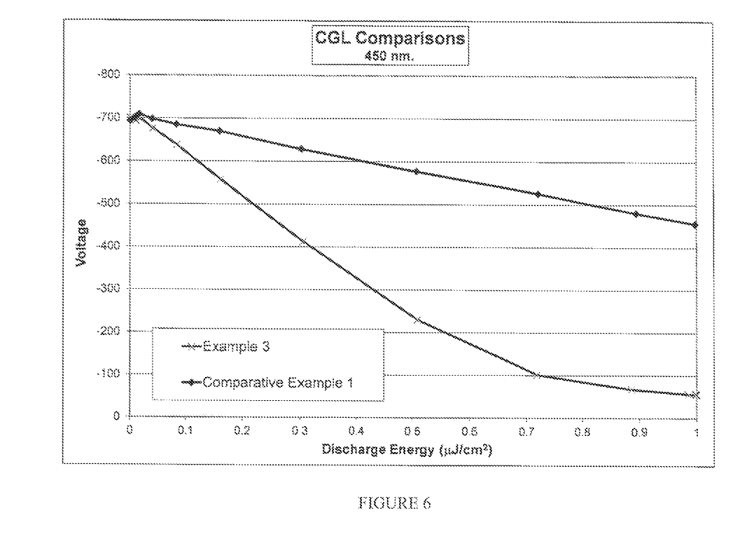

The data presented in FIG. 6 was derived using an electrostatic tester, PDT-2000LA Advanced Photoconducting Drum/Charge Roller Test System, available from Quality Engineering Associates, Inc. of Burlington, Mass. Light emission is from a broad band light source equipped with filters to give an emission wavelength centered at 450 nm.

### Example 1

The first charge generation layer dispersion was prepared from a mixture including type IV titanyl phthalocyanine, polyvinyl butyral (BX-1 from Sekisui Chemical Co.), poly(methyl-phenyl)siloxane and polyhydroxystyrene at a weight ratio of 45:27.5:24.75:2.75 in a mixture of 2-butanone and cyclohexanone solvents. The first charge generation layer dispersion was coated onto an aluminum substrate through dip coating and allowed to stand at room temperature for 1 hour to form the first charge generation layer having a thickness of less than 1 μm, specifically a thickness of about 0.2 μm to about 0.3 μm. This charge generation layer had been optimized previously to provide a photoconductor with high sensitivity.

### Example 2

The second charge generation layer dispersion was prepared from a mixture including the bisazo pigment of formula (3) and BX-1 polyvinyl butyral at a weight ration of pigment to binder of 70/30. The second charge generation layer dispersion was coated onto an aluminum substrate through dip coating and allowed to stand at room temperature for 1 hour to form the second charge generation layer having a thickness of less than 1 μm, specifically a thickness of about 0.2 μm to about 0.3 μm.

### Example 3

The first charge generation layer dispersion prepared in Example 1 was deposited over an electrically conductive substrate by dip coating and allowed to stand at room temperature for 1 hour to provide a first charge generation layer having a thickness of less than 1 μm, specifically a thickness of about 0.2 μm to about 0.3 μm. The second charge generation layer dispersion was then deposited over the first charge generation layer by dip coating to form a second charge generation layer having a thickness of less than 1 μm, specifically a thickness of about 0.2 μm to about 0.3 μm.

The charge transport layer was prepared from a formulation including a of tritolylamine (TTA), 1,1 bis(di-4-tolylaminophenyl)cyclohexane (TAPC) and polycarbonate A at a weight ratio of 45/5/50 in a mixed solvent of THF and 1,4-dioxane. The charge transport formulation was coated on top of the second charge generation layer and heated at 100° C. for 1 hour to form the charge transport layer having a thickness of about 22 μm to about 24 μm as measured by an eddy current tester.

### Comparative Example 1

The first charge generation layer dispersion prepared in Example 1 was deposited over an electrically conductive substrate by dip coating and allowed to stand at room temperature for 1 hour to provide a first charge generation layer having a thickness of less than 1 μm, specifically a thickness of about 0.2 μm to about 0.3 μm. In this example, the first charge generations layer is the only charge generation layer coated.

The charge transport layer was prepared from a formulation including a of tritolylamine (TTA), 1,1 bis(di-4-tolylaminophenyl)cyclohexane (TAPC) and polycarbonate A at a weight ratio of 45/5/50 in a mixed solvent of THF and 1,4-dioxane. The charge transport formulation was coated on top of the first charge generation layer and heated at 100° C. for 1 hour to form the charge transport layer having a thickness of about 22 μm to about 24 μm as measured by an eddy current tester.

### Comparative Example 2

The first charge generation layer dispersion prepared in Example 2 was deposited over an electrically conductive substrate by dip coating and allowed to stand at room temperature for 1 hour to provide a second charge generation layer having a thickness of less than 1 μm, specifically a thickness of about 0.2 μm to about 0.3 μm. In this example, the second charge generations layer is the only charge generation layer coated.

The charge transport layer was prepared from a formulation including a of tritolylamine (TTA), 1,1 bis(di-4-tolylaminophenyl)cyclohexane (TAPC) and polycarbonate A at a weight ratio of 45/5/50 in a mixed solvent of THF and 1,4-dioxane. The charge transport formulation was coated on top of the second charge generation layer and cured at 100° C. for 1 hour to form the charge transport layer having a thickness of about 22 μm to about 24 μm as measured by an eddy current tester.

FIG. 4 shows the voltage versus exposure energy curves at 780 nm for photoconductor drums prepared in Example 3 and Comparative Examples 1, 2. The region of the voltage versus exposure energy curve that is dominated by properties of the charge generation layer is between 0 and about 0.2 μJ/cm². Charge generation layers comprising titanylphthalocyanine and bisazo pigment produce more electron-hole pairs than charge generation layers comprising either titanyl phthalocyanine or bisazo pigment. This is unexpected since, as shown in FIG. 4, the bisazo pigment charge generation layer of Comparative Example 2 does not discharge under 780 nm irradiation. The n-type bisazo pigment may be acting as a sensitizer to increase the photogeneration efficiency of the titanyl phthalocyanine and provide a more sensitive charge generation layer.

FIG. 5 shows the voltage versus pulse width modulation (PWM) curves for photoconductor drums prepared in Examples 3 and Comparative Examples 1, 2. PWM refers to changing the pulse width, (the time that the laser is discharging the drum surface) in order to deliver smaller or larger spot sizes, and deliver more or less light energy to the photoconductor. In other words, laser power is kept constant, and the energy provided to the photoconductor surface is changed by varying the length of the light pulse. This method is often used in the laser printer industry to optimize print properties such as uniformity, single-pel development and grey scale range. The measurements were recorded in a Lexmark E460dn monochrome laser printer equipped to measure electrostatic charge on the photoconductor. The exposure source is a 650 nm LED. Titanyl phthalocyanine absorbs a much smaller fraction of incident light at 650 nm than at 780 nm, and is thus not the best choice for printing at this wavelength. The Photoconductor drum comprising a first charge generation layer (titanyl phthalocyanine) and a second charge generation layer (bisazo pigment) prepared in Example 3 shows a lower discharge voltage (higher PID) at a given PWM than the photoconductor of Comparative Example 1. This means that a higher electrical contrast exists between charged and discharged areas. The effect is darker print at lower exposure energies. This is an important attribute, especially for high speed printing. Increasing print speed leads to lower imaging exposure times. The ability to create dark print from low exposure energies (low exposure times) is an advantage in high speed printing applications. The photoconductor of Example 3 matches the curve of Comparative Example 2 at most PWM values. Since the bisazo pigment absorbs strongly at 650 nm the PID is a function of both the titanyl phthalocyanine and the bisazo pigment.

FIG. 6 shows the voltage versus exposure energy curves at 450 nm for photoconductor drums prepared in Example 3 and Comparative Example 1. The Photoconductor drum comprising a first charge generation layer (titanyl phthalocyanine) and a second charge generation layer (bisazo pigment) prepared in Example 3 shows a lower discharge voltage (higher PID) at a given exposure energy than the photoconductor of Comparative Example 1. Since titanyl phthalocyanine does not strongly absorb at this wavelength, most of the PID is a function of the bisazo pigment. In fact, the photoconductor drum of Comparative Example 1 comprising only titanyl phthalocyanine cannot be viewed as a viable photoconductor for use in a modern laser printer. The electrical contrast between charged (about −700V) and discharged areas (about −450V at 1.0 μJ/cm²) is not adequate to provide a full range of darkness levels to a printed image.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

What is claimed is:

1. A photoconductor, comprising:
an electrically conductive substrate;
a first charge generation layer disposed over the electrically conductive substrate, wherein the charge generation layer comprises titanyl phthalocyanine, binder and optional additives,
a second charge generation layer disposed over the first charge generation layer, wherein the second charge generation layer comprises a bisazo pigment, binder and optional additives; and
a charge transport layer disposed over the second charge generation layer.

2. The photoconductor of claim 1 wherein the titanyl phthalocyanine in the first charge generation layer is selected from the group consisting of Type I titanyl phthalocyanine, and Type IV titanyl phthalocyanine, or a combination thereof.

3. The photoconductor of claim 2 wherein the titanyl phthalocyanine in the first charge generation layer is Type I titanyl phthalocyanine.

4. The photoconductor of claim 2 wherein the titanyl phthalocyanine in the first charge generation layer is Type IV titanyl phthalocyanine.

5. The photoconductor of claim 1 wherein the bisazo pigment in the second charge generation layer comprises a bisazo pigment having the general structure shown below: 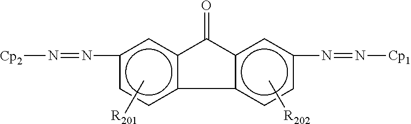
wherein Cp₁ and Cp₂ each independently represent a coupler residue, and R₂₀₁ and R₂₀₂ each independently represent a hydrogen atom, a halogen atom, an alkyl group, an alkoxy group or a cyano group.

6. The photoconductor of claim 5 wherein the coupler residues Cp₁ and Cp₂ have the general structure shown below: 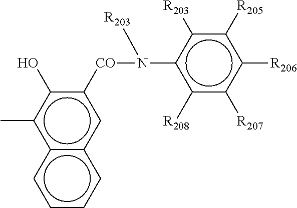
wherein R₂₀₃ independently represents a hydrogen atom, an alkyl group or an aryl group and R₂₀₄, R₂₀₅, R₂₀₆, R₂₀₇ and R₂₀₈ each independently represent a hydrogen atom, a halogen atom a nitro group, a cyano group, an alkyl group, an alkoxy group, a dialkylamino group or a hydroxyl group.

7. The photoconductor of claim 5 wherein the bisazo pigment has the formula shown below:

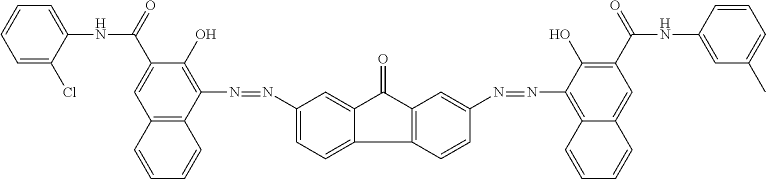 [SMILES: Cc1cccc(NC(=O)c2cc3ccccc3c(N=Nc3ccc4c(c3)C(=O)c3cc(N=Nc5c(O)c(C(=O)Nc6ccccc6Cl)cc6ccccc56)ccc3-4)c2O)c1]

8. The photoconductor of claim 1 wherein the binder of the first charge generation layer and the second charge generation layer is selected from the group consisting of polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like resins.

9. The photoconductor of claim 1 wherein the binder of the first charge generation layer is the same as the binder for the second charge generation layer.

10. The photoconductor of claim 1 wherein the binder of the first charge generation layer is different from the binder for the second charge generation layer.

11. The photoconductor of claim 8 wherein the binder of the first charge generation layer and the second charge generation layer is polyvinyl butyral.

12. The photoconductor of claim 1 wherein the first charge generation layer and the second charge generation layer each independently comprise a thickness of about 0.1 μm to about 1.0 μm.

13. The photoconductor of claim 1 wherein the charge transport layer comprises an aromatic amine and a polycarbonate in an organic solvent.

14. The photoconductor of claim 1 wherein the charge transport layer comprises a thickness of about 15 μm to about 30 μm.
